(19) United States
(12) Patent Application Publication
(10) Pub. No.: US 2005/0143501 A1
(43) Pub. Date: Jun. 30, 2005

(54) Polycarbonate resin molding

(75) Inventors: Tadahisa Sato, Kanagawa (JP); Takashi Usami, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/016,915

(22) Filed: Dec. 21, 2004

(30) Foreign Application Priority Data
Dec. 25, 2003 (JP) P.2003-428966

(51) Int. Cl. C08K 5/34

(52) U.S. Cl. 524/104

(57) ABSTRACT

A polycarbonate resin molding comprising a polycarbonate resin composition, wherein the polycarbonate resin composition comprises: a polycarbonate resin; at least one of an ultraviolet absorber and a fluorescent whitening agent; a hindered amine; and a hindered phenol, wherein the polycarbonate resin molding has a light transmittance of 0.1% or lower in a wavelength of not longer than 410 nm, and a lamp cover comprising the resin molding.

### BACKGROUND OF THE INVENTION

1. Field of the Invention

The present invention relates to a polycarbonate resin molding which cuts off the ultraviolet emitted by illuminators such as HID lamps (High Intensity Discharge lamps; a general term for metal halide lamps, high-pressure sodium lamps, and mercury lamps, which emit a light based on a discharge in a metal vapor; also called high intensity discharge illuminators), the ultraviolet being harmful to the human body and causative of attraction for flying insects. The invention further relates to a filter made of the polycarbonate resin molding.

2. Description of the Related Art

Articles such as films for application to windows and lamp covers are on the market which contain an ultraviolet absorber for the purpose of shielding from the ultraviolet which is included in sunlight and is harmful to the human body or from the ultraviolet which is emitted by fluorescent lamps, incandescent lamps, tungsten halogen lamps, or the like and is causative of attraction for flying insects. However, these articles have the following drawbacks. Some of the articles have an absorption-edge wavelength shorter than 380 nm so as to be reduced in yellowness, while other articles have enhanced yellowness although capable of absorbing longer-wavelength rays ranging to 410 nm. Still other articles contain a dye or pigment for color tone regulation so as to reduce yellowness at the sacrifice of light transmittance in the visible region. Furthermore, white laminated polyester films have been proposed which contain a fluorescent whitening agent in combination with an ultraviolet absorber so as to be reduced in yellowness change caused by ultraviolet irradiation and which are excellent in weatherability, whiteness, and adhesiveness (see JP-A-11-291432 and JP-A-11-268214). However, the same drawbacks remain unsolved. Moreover, a composition comprising a transparent resin containing a fluorescent whitening agent has been proposed for use as a cover for cutting off fluorescent lamp ultraviolet (see JP-B-6-3682). However, no ultraviolet-cutting lamp cover is known which withstands use in HID lamps represented by mercury lamps, which have an ultraviolet irradiation intensity several tens of times the ultraviolet irradiation intensity of fluorescent lamps.

### SUMMARY OF THE INVENTION

An object of the invention is to provide a lamp cover which contains a fluorescent whitening agent emitting blue fluorescence, a complement for yellow, and hence has no yellowness and high transparency even when it cuts off light having wavelengths ranging to 410 nm, i.e., having wavelengths longer than 405 nm, especially than 380 nm, and which does not deteriorate even in intense ultraviolet, in order to eliminate the problems of the related-art techniques described above.

The present inventors made intensive investigations in order to accomplish the object. As a result, they have found that a filter for cutting off ultraviolet which is made of a plastic containing an ultraviolet absorber and/or a fluorescent whitening agent, a hindered amine, and a hindered phenol eliminates the problems described above. The invention has been thus achieved. Namely, the invention provides the following.

(1) A polycarbonate resin molding comprising a polycarbonate resin composition,
wherein the polycarbonate resin composition comprises: a polycarbonate resin; at least one of an ultraviolet absorber and a fluorescent whitening agent; a hindered amine; and a hindered phenol,
wherein the polycarbonate resin molding has a light transmittance of 0.1% or lower in a wavelength of not longer than 410 nm.

(2) The polycarbonate resin molding as described in (1) above, comprising:
at least one of (A) 0.01 to 30% by weight of the ultraviolet absorber and (B) 0.01 to 30% by weight of the fluorescent whitening agent;
(C) 0.01 to 30% by weight of the hindered amine; and
(D) 0.01 to 30% by weight of the hindered phenol, each based on the polycarbonate resin.

(3) The polycarbonate resin molding as described in (1) or (2) above, further comprising a protective layer as an outermost layer of the polycarbonate resin molding.

(4) The polycarbonate resin molding as described in (3) above,
wherein the protective layer is an acrylic coat.

(5) An illuminator cover comprising a polycarbonate resin molding as described in any of (1) to (4) above.

(6) The illuminator cover as described in (5) above, which covers an HID (High Intensity Discharge) lamp.

(7) The illuminator cover as described in (5) above, which covers an illuminator for a vehicle.

(8) An illuminator lens comprising a polycarbonate resin molding as described in any of (1) to (4) above.

(9) The illuminator lens as described in (8) above, which covers an illuminator for a vehicle.

(10) The polycarbonate resin molding as described in any of (1) to (4) above,
wherein the fluorescent whitening agent is represented by formula (I): 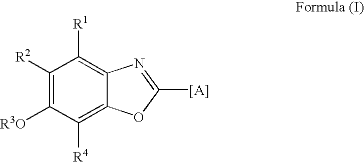
wherein R¹ and R⁴ each independently represents a hydrogen atom, an alkyl group or an alkoxy group;
R² and R³ each independently represents an alkyl group; and
[A] represents a substituted aryl group or a substituted ethenyl group.

(11) The polycarbonate resin molding as described in any of (1) to (4) and (10) above,
wherein the fluorescent whitening agent is represented by formula (II): 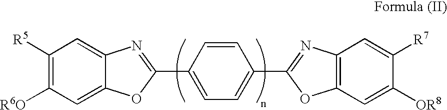
wherein R⁵ to R⁸ each independently represents an alkyl group; and
n represents an integer of 1 or 2.

The invention further provides the following.

(12) A method for producing a polycarbonate resin molding, comprising:
extrusion molding a polycarbonate resin composition, so as to form an extruded polycarbonate resin composition; and
blow molding the extruded polycarbonate resin composition,
wherein the polycarbonate resin composition comprises: at least one of an ultraviolet absorber and a fluorescent whitening agent; a hindered amine; and a hindered phenol.

(13) A method for producing a polycarbonate resin molding, comprising injection molding a polycarbonate resin composition,
wherein the polycarbonate resin composition comprises: at least one of an ultraviolet absorber and a fluorescent whitening agent; a hindered amine; and a hindered phenol.

### BRIEF DESCRIPTION OF THE DRAWING

FIG. 1 is a graphic presentation showing ultraviolet absorption spectra of sample plate 1 of the invention and a commercial polycarbonate plate (thickness, 5 mm).(Example 1)

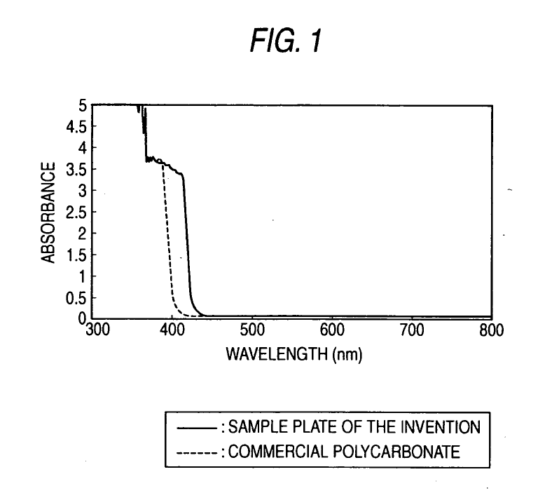

### DETAILED DESCRIPTION OF THE INVENTION

The invention will be explained below in detail.

In general, a fluorescent whitening agent comprises a compound having the property of absorbing light having wavelengths of about 320 to 410 nm and emitting light having wavelengths of about 410 to 500 nm. Textiles dyed with such fluorescent whitening agents emit white reflected light because the blue light having wavelengths of about 410 to 500 nm emitted by the fluorescent whitening agents are newly added to the original yellow reflected light. In addition, since the energy of the visible light increases by an amount corresponding to that brought about by the fluorescent effect, this resulted in enhanced whiteness. When incorporated into plastics, these fluorescent whitening agents come to withstand an ultraviolet irradiation intensity on a level almost the same as that of fluorescent lamps. However, it is necessary to add a light stabilizer for obtaining a composition, which withstands HID lamps that have an ultraviolet irradiation intensity several tens of times the ultraviolet irradiation intensity of fluorescent lamps. As a result of intensive investigations, it has been found that the light resistance of ultraviolet absorbers and/or fluorescent whitening agents is improved by using a combination of a hindered amine and a hindered phenol. The plastic base polymer, fluorescent whitening agent, ultraviolet absorber, hindered amine, hindered phenol, and other ingredients to be used in the invention will be explained below. In this specification, the term “resin” indicates a resin itself, the term “resin composition” indicates a mixture of the resin and an additive(s) and the term “resin molding” indicates a substance where the resin composition is subjected to molding.

Examples of the plastic base polymer include commercial polymers such as aromatic or aliphatic polyurethanes, aromatic or aliphatic polyesters, aromatic or aliphatic polyamides, aromatic or aliphatic polyureas, aromatic or aliphatic polycarbonates, and copolymers of these. Preferred are polycarbonates.

For the purpose of improving light resistance, the surface may be coated with a highly light-resistant resin such as an acrylic, for example, by the method described in JP-B-47-019119 or JP-B-44-029756.

The fluorescent whitening agent can be selected at will from commercial ones or from novel substances based on light resistance, etc.

Examples of commercial fluorescent whitening agents include the compounds represented by the following structural formulae 1 to 16. However, the fluorescent whitening agent to be used should not be construed as being limited to these.

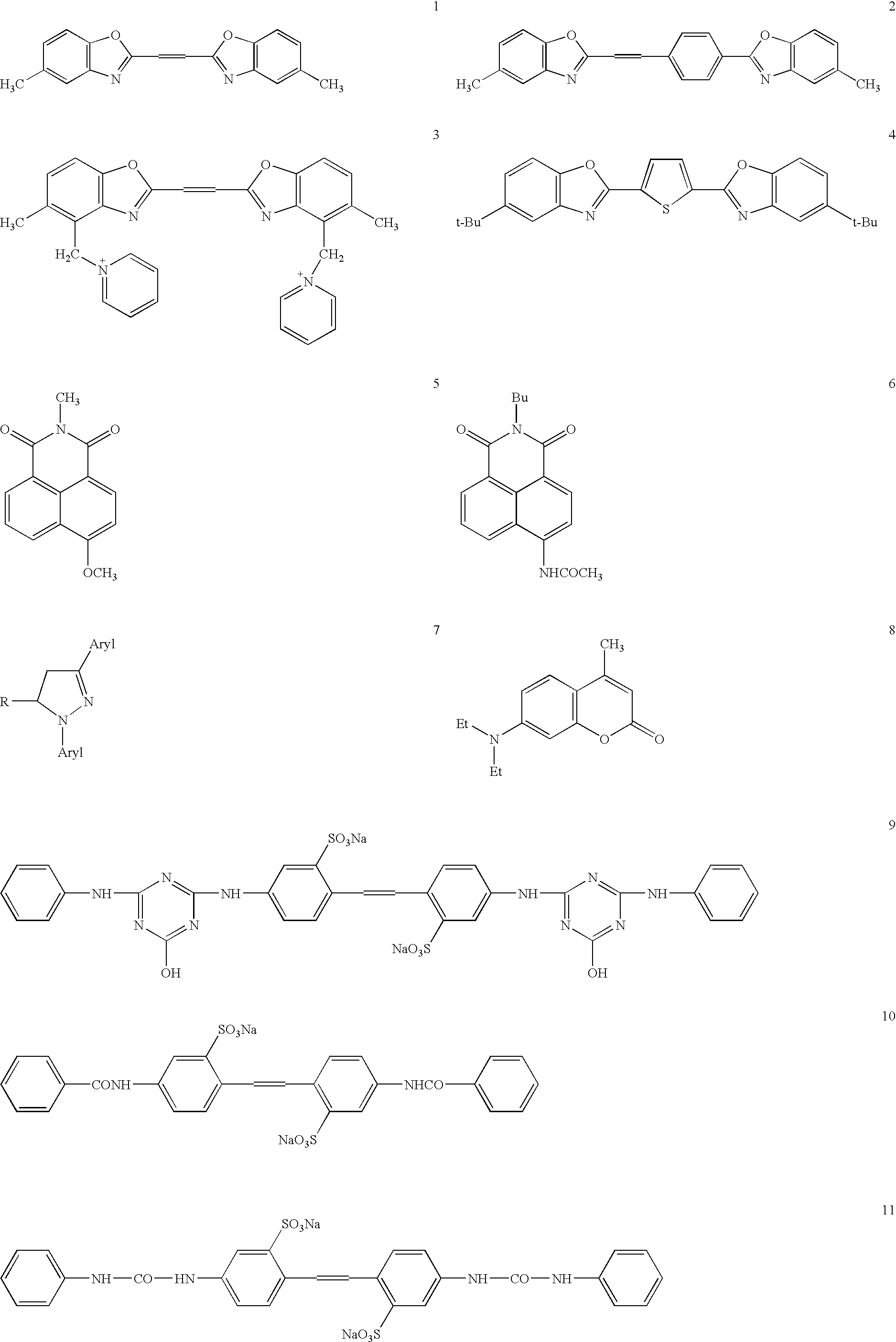

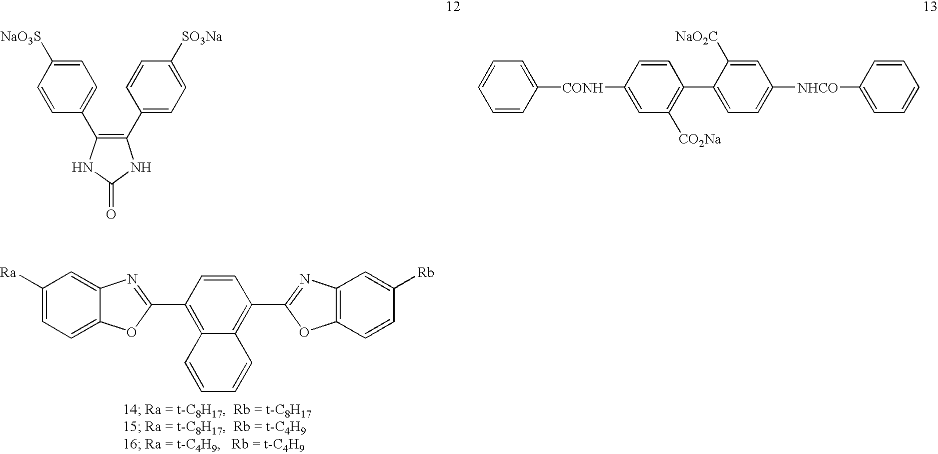

Compounds represented by the following general formula (I) also are preferred as the fluorescent whitening agent, although not commercially available.

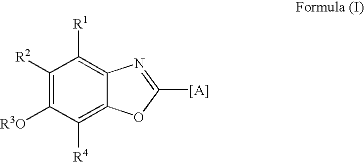

In the formula, R¹ and R⁴ each independently represents a hydrogen atom, an alkyl group, or an alkoxy group, and R² and R³ each independently represents an alkyl group. [A] represents a substituted aryl group or a substituted ethenyl group.

Although R¹ and R⁴ each independently represents a hydrogen atom, an alkyl group, or an alkoxy group, they each preferably represents a hydrogen atom, an alkyl group having 1 to 8 carbon atoms, or an alkoxy group having 1 to 8 carbon atoms. Examples of R¹ and R⁴ include a hydrogen atom; alkyl groups such as methyl, ethyl, n-propyl, n-butyl, n-octyl, isopropyl, isobutyl, 2-ethylhexyl, t-butyl, t-amyl, t-octyl, cyclopentyl, and cyclohexyl; and alkoxy groups such as methoxy, ethoxy, n-propoxy, n-butoxy, n-octyloxy, isopropoxy, isobutoxy, 2-ethylhexyloxy, t-butoxy, and cyclohexyloxy. R¹ and R⁴ each preferably are a hydrogen atom or an alkyl group, and especially preferably are a hydrogen atom.

Although R² and R³ each independently represents an alkyl group, they each preferably represent an alkyl group having 1-16 carbon atoms. Examples thereof include alkyl groups such as methyl, ethyl, n-propyl, n-butyl, n-octyl, n-hexadecanyl (cetyl), isopropyl, isobutyl, 2-ethylhexyl, t-butyl, t-amyl, t-octyl, cyclopentyl, and cyclohexyl. Preferably, R² is methyl, isopropyl, t-butyl, or cyclohexyl, and R³ is methyl, ethyl, n-propyl, n-butyl, n-pentyl, n-hexyl, or 2-ethylhexyl. Especially preferably, R² is t-butyl or cyclohexyl, and R³ is methyl, n-butyl, n-octyl, or 2-ethylhexyl.

Although [A] represents a substituted aryl group or a substituted ethenyl group, it preferably represents a substituted aryl group having 6 to 40 carbon atoms or a substituted ethenyl group having 8 to 40 carbon atoms. More preferably, [A] represents any of the substituted aryl group and a substituted ethenyl groups shown below.

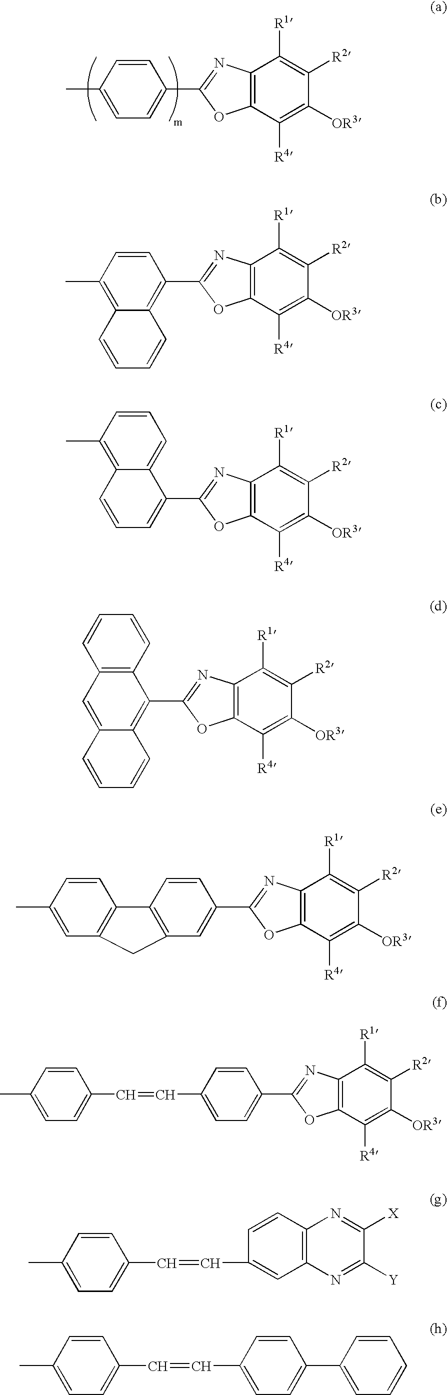

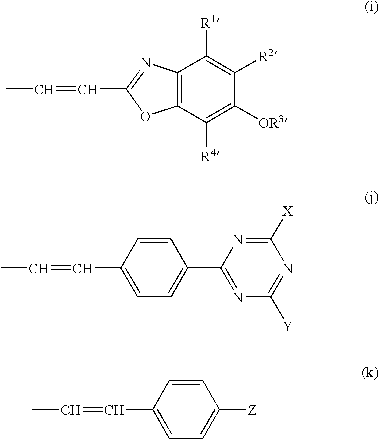

In the formulae, R¹′ and R⁴′ have the same meanings as R¹ and R⁴, and the preferred ranges thereof also are the same. R²′ and R³′ have the same meanings as R² and R³, respectively, and the preferred ranges thereof also are the same. Symbol m represents an integer of 1 to 5. X, Y and Z each independently represents an alkyl, aryl, alkoxy, alkylamino, arylamino, amino, or hydroxy group.

Specific examples of X and Y other than amino and hydroxy include alkyl groups such as methyl, ethyl, isopropyl, t-butyl, and cyclohexyl; aryl groups such as phenyl, tolyl, and naphthyl; alkoxy groups such as methoxy, ethoxy, and isopropoxy; alkylamino groups such as methylamino, ethylamino, octylamino, dimethylamino, and N-methyl-N-ethylamino; and arylamino groups such as anilino, 4-tolylamino, and N-methylanilino. X and Y each preferably are an aryl, alkoxy, or anilino group.

The compounds represented by general formula (I) preferably are compounds represented by the following general formula (II).

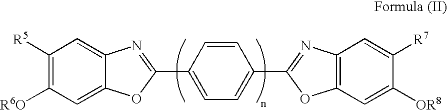

In the formula, R⁵ and R⁷ each have the same meaning as R², and R⁶ and R⁸ each have the same meaning as R³. The preferred ranges of these also are the same. Symbol n represents an integer of 1 or 2. These compounds can be synthesized by the method described in JP-A-11-29556.

Specific examples of the compounds represented by general formulae (I) and (II) are shown below, but the invention should not be construed as being limited by the following examples in any way.

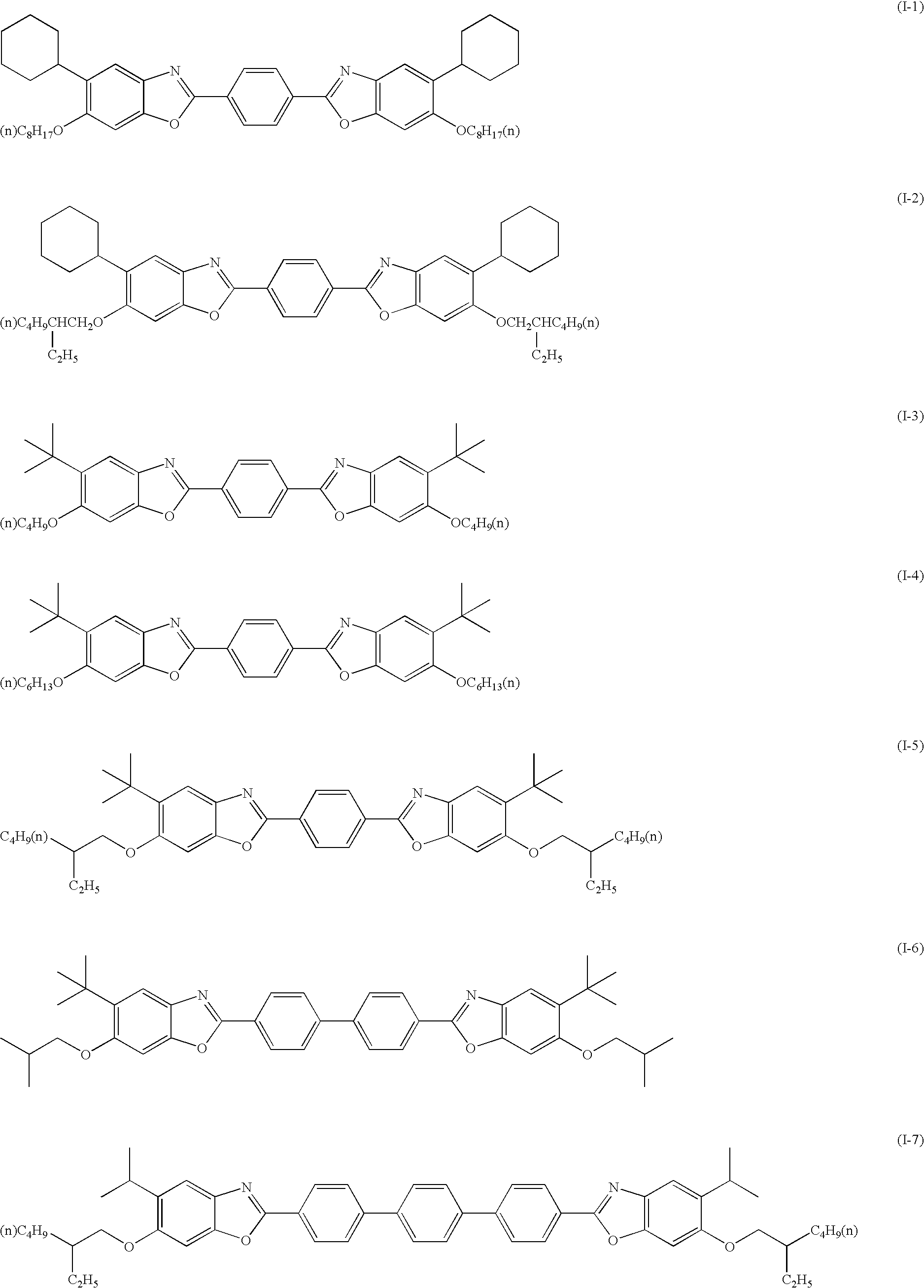

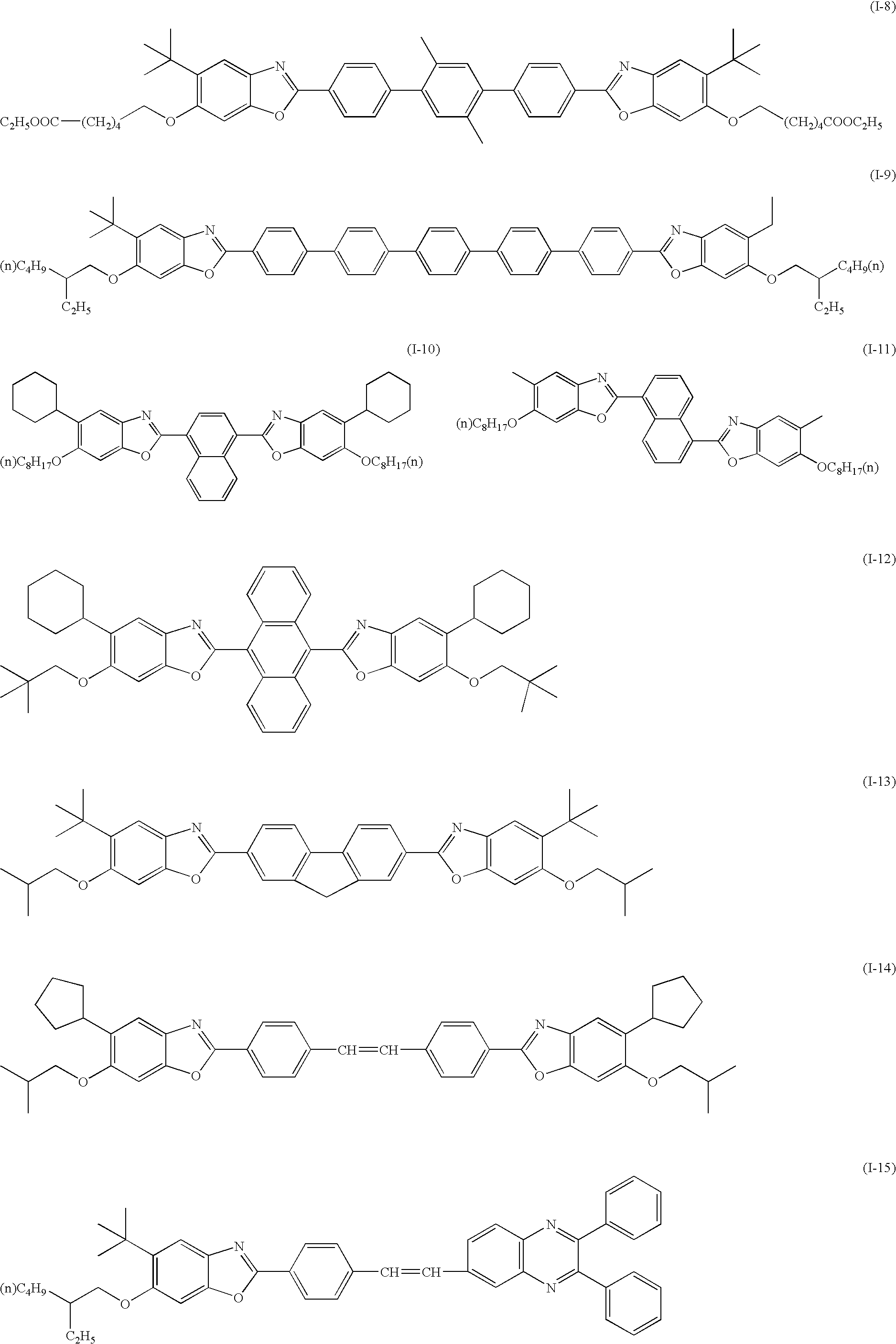

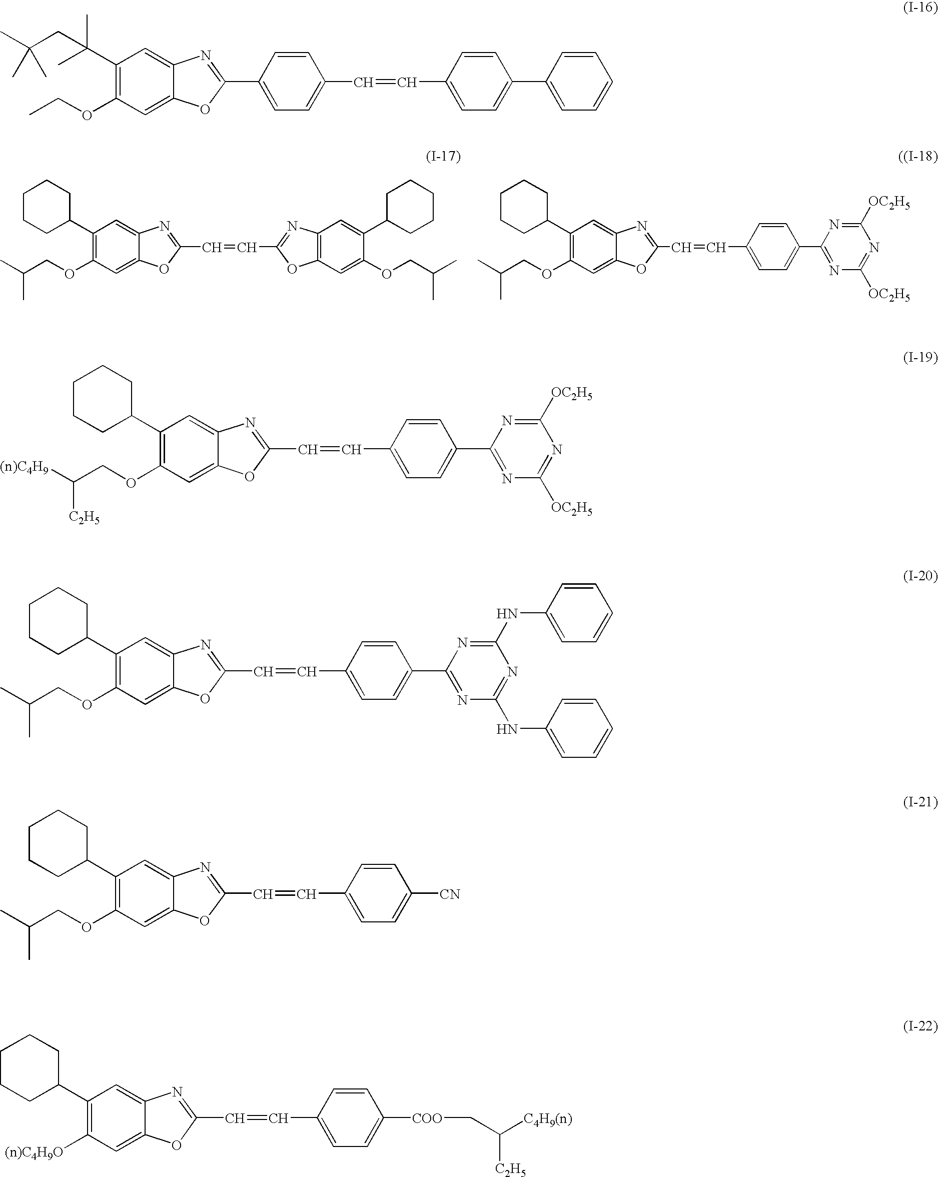

Although examples of organic materials were explained above, the fluorescent whitening agent is not limited to these and inorganic materials also can be used. These fluorescent whitening agents can be used alone or in combination of two or more thereof. The amount of the fluorescent whitening agent to be added cannot be unconditionally fixed because it varies depending on the thickness of the resin molding, properties of the fluorescent whitening agent, presence or absence of an ultraviolet absorber, and properties and addition amount of the ultraviolet absorber. However, persons skilled in the art can easily determine the amount thereof through some tests. In general, in the case of a resin molding having a thickness of 1 mm, it is sufficient to add the fluorescent whitening agent in an amount of 0.01 to 30% by weight, preferably 0.1 to 15% by weight. It can be thought that the amount of the agent to be added (% by weight) is almost inversely proportional to the thickness of the material to which the agent is to be added. An especially preferred range of the addition amount thereof is 0.1 to 10% by weight.

In the invention, the object can be accomplished by incorporating a fluorescent whitening agent into a resin composition. However, in the case where the fluorescent whitening agent has insufficient light resistance or where light in a short-wavelength region cannot be sufficiently cut off with the fluorescent whitening agent alone, it is desirable to use an ultraviolet absorber in combination with the fluorescent whitening agent. In general, ultraviolet absorbers are compounds having the property of absorbing ultraviolet and converting it into heat. Such compounds are roughly divided into benzotriazole compounds, benzophenone compounds, salicylic acid compounds, and cyanoacrylate compounds, and the ultraviolet absorber to be used can be selected from known ones at will. The benzotriazole compounds have effective absorption wavelengths of about 270 to 380 nm, and typical examples thereof include 2-(2′-hydroxy-5′-methylphenyl)benzotriazole, 2-(2′-hydroxy-5′-t-butylphenyl)benzotriazole, 2-(2′-hydroxy-3′,5′-di-t-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-3′,5′-di-t-amylphenyl)-benzotriazole, and 2-(2′-hydroxy-4′-octoxyphenyl)benzotriazole.

The benzophenone compounds have effective absorption wavelengths of about 270 to 380 nm, and typical examples thereof include 2,4-dihydroxybenzophenone, 2-hydroxy-4-methoxy-benzophenone, 2-hydroxy-4-octoxybenzophenone, 2-hydroxy-4-dodecyloxybenzophenone, 2,2′-dihydroxy-4-methoxy-benzophenone, 2,2′-dihydroxy-4,4′-dimethoxybenzophenone, and 2-hydroxy-4-methoxy-5-sulfobenzophenone.

The salicyclic acid compounds have effective absorption wavelengths of about 290 to 330 nm, and typical examples thereof include phenyl salicylate, p-t-butylphenyl salicylate, and p-octylphenyl salicylate.

The cyanoacrylate compounds have effective absorption wavelengths of about 270 to 350 nm, and typical examples thereof include 2-ethylhexyl 2-cyano-3,3-diphenylacrylate and ethyl 2-cyano-3,3-diphenylacrylate.

Those ultraviolet absorbers can be used alone or in combination of two or more thereof. A preferred range of the addition amount thereof cannot be unconditionally fixed because it varies depending on the thickness of the resin molding, properties of the fluorescent whitening agent, etc. However, persons skilled in the art can easily determine the range through some tests. In general, in the case of a resin molding having a thickness of 1 mm, it is sufficient to add an ultraviolet absorber in an amount of 0.01 to 30% by weight, preferably 0.1 to 15% by weight. It can be thought that the amount of the ultraviolet absorber to be added (% by weight) is almost inversely proportional to the thickness of the material to which the absorber is to be added. An especially preferred range of the addition amount thereof is 0.1 to 10% by weight. For adding the ingredients described above to a resin composition and mixing these, any desired method can be used.

The hindered amine to be used in the invention may be a compound selected from commercial hindered-amine products; use of it produces a sufficient effect. Typical examples thereof include bis(2,2,6,6-tetramethyl-4-piperidyl) sebacate, bis(1,2,2,6,6-pentamethyl-4-piperidyl) sebacate, bis(1-octyloxy-2,2,6,6-tetramethyl-4-piperidyl) sebacate, and dimethyl succinate/1-(2-hydroxyethyl)-4-hydroxy-2,2,6,6-tetramethylpiperidine polycondensates.

Those hindered amines can be used alone or in combination of two or more thereof. A preferred range of the addition amount thereof cannot be unconditionally fixed because it varies depending on the thickness of the resin molding, properties of the fluorescent whitening agent, etc. However, persons skilled in the art can easily determine the range through some tests. In general, in the case of a resin molding having a thickness of 1 mm, it is sufficient to add a hindered amine in an amount of 0.01 to 30% by weight, preferably 0.1 to 15% by weight. It can be thought that the amount of the hindered amine to be added (% by weight) is almost inversely proportional to the thickness of the material to which the hindered amine is to be added. An especially preferred range of the addition amount thereof is 0.1 to 10% by weight. For adding the ingredient described above to a resin composition and mixing these, any desired method can be used.

The hindered phenol to be used in the invention may be a compound selected from commercial hindered-phenol products; use of it produces a sufficient effect. Typical examples thereof include triethylene glycol bis[3-(3-t-butyl-5-methyl-4-hydroxyphenyl)propionate], 1,6-hexanediol bis[3-(3,5-di-t-butyl-4-hydroxyphenyl)propionate], 2,4-bis(n-octylthio)-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl 3-(3,5-di-t-butyl-4-hydroxyphenyl)propionate, and N,N′hexamethylene bis(3,5-di-t-butyl-4-hydroxy-hydrocinnamamide).

Those hindered phenols can be used alone or in combination of two or more thereof. A preferred range of the addition amount thereof cannot be unconditionally fixed because it varies depending on the thickness of the resin molding, properties of the fluorescent whitening agent, etc. However, persons skilled in the art can easily determine the range through some tests. In general, in the case of a resin molding having a thickness of 1 mm, it is sufficient to add a hindered phenol in an amount of 0.01 to 30% by weight, preferably 0.1 to 15% by weight. It can be thought that the amount of the hindered phenol to be added (% by weight) is almost inversely proportional to the thickness of the material to which the hindered phenol is to be added. An especially preferred range of the addition amount thereof is 0.1 to 10% by weight. For adding the ingredient described above to a resin composition and mixing these, any desired method can be used.

The protective layer in the invention is explained next. Although the kind of the protective layer is not particularly limited, the layer preferably is an acrylic coat. There are no particular limitations on layer constitution. It is, however, preferred that the protective layer be an outermost layer.

### EXAMPLES

The invention will be explained below based on Examples, but the invention should not be construed as being limited by these Examples in any way.

### Example 1

Exemplified Compound (1-1) and 2-(2′-hydroxy-5′-t-butylphenyl)benzotriazole were added to polycarbonate 7030 PJ, manufactured by Mitsubishi Engineering-Plastic Corp., each in an amount of 0.21% by weight based on the polycarbonate. Thereto were further added LA-77 and Irganox 1035, which are additives shown below, each in an amount of 0.21% by weight based on the polycarbonate. Thus, sample 1 was prepared. Subsequently, sample 2 was prepared in the same manner as that shown above, except that only the amount of each additive was changed to 0.42% by weight based on the polycarbonate. Furthermore, comparative samples 1 to 7 were prepared in the same manner as that shown above, except that the additives used for sample 1 were omitted or these additives were replaced by the additives shown in Table 1.

These samples each were melt-kneaded with a 50-mm single-screw extruder at an internal temperature of 280° C. to obtain pellets. The pellets obtained were processed with an injection molding machine to obtain test pieces having dimensions of 20 mm×50 mm and a thickness of 1 mm. The test piece obtained from sample 1 and the test piece obtained from sample 2 are referred to as sample plate 1 of the invention and sample plate 2 of the invention, respectively. The test pieces obtained from the comparative samples are respectively referred to as comparative sample plates 1 to 7.

These sample plates were subjected to a 21-day exposure test with a xenon fadeometer at an ultraviolet irradiation intensity of 4.6 MW/cm² and a visible light illuminance of 17×10⁴ lx. In Table 1 are shown the changes in 410 nm absorbance and the results of the visual evaluation of yellowing. The sample plates of the invention showed only a slight change in 410 nm absorbance, and almost no yellowing was visually observed thereon in contrast to the case of the comparative sample plates.

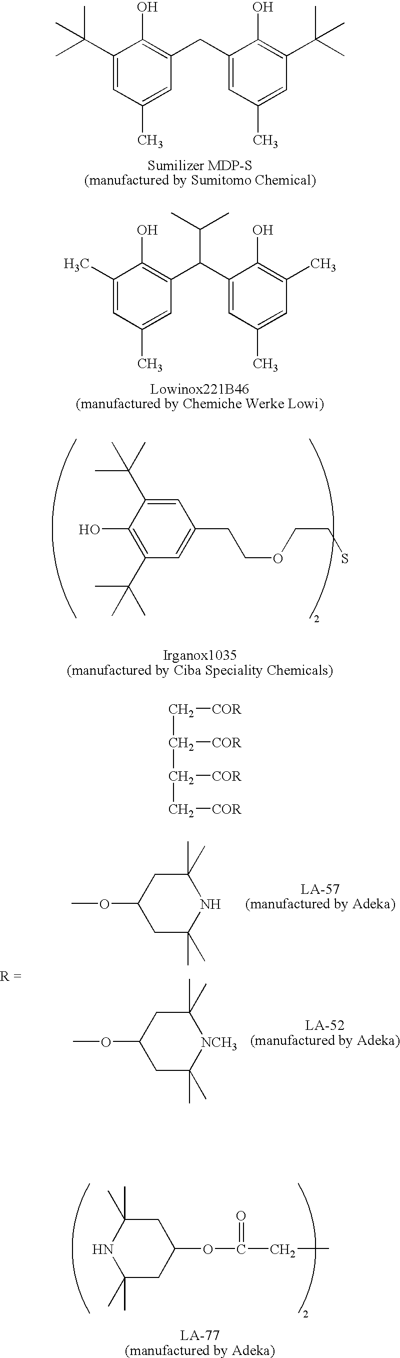

TABLE 1

| | | | | Yellowing |
|---|---|---|---|---|
| | Name of | | | (visual |
| No. | additive | Type | ΔD₄₁₀ | examination) |
| Sample | LA77 + Irganox 1035 | hybrid | 0.104 | slight |
| plate 1 | (0.21% by weight | | | yellowing |
| of the | each) | | | |
| invention | | | | |
| Sample | LA77 + Irganox 1035 | hybrid | 0.080 | almost |
| plate 2 | (0.42% by weight | | | unchanged |
| of the | each) | | | |
| invention | | | | |
| Comparative | none | none | 0.350 | considerable |
| sample | | | | yellowing |
| plate 1 | | | | |
| Comparative | Sumilizer MDP-S | phenol | 0.384 | considerable |
| sample | | | | yellowing |
| plate 2 | | | | |
| Comparative | Lowinox 221B46 | phenol | 0.330 | considerable |
| sample | | | | yellowing |
| plate 3 | | | | |
| Comparative | Irganox 1035 | phenol | 0.254 | considerable |
| sample | | | | yellowing |
| plate 4 | | | | |
| Comparative | LA-57 | amine | 0.355 | considerable |
| sample | | | | yellowing |
| plate 5 | | | | |
| Comparative | LA-77 | amine | 0.358 | considerable |
| sample | | | | yellowing |
| plate 6 | | | | |
| Comparative | LA-52 | amine | 0.578 | considerable |
| sample | | | | yellowing |
| plate 7 | | | | |

### Example 2

The sample plate 1 of the invention produced in Example 1 was subjected to the surface acrylic coating treatment described in JP-B-44-29756. This coated plate is referred to as sample plate 3 of the invention. Furthermore, a polycarbonate plate containing no additive is referred to as comparative sample plate 8, and a sample obtained by subjecting the comparative sample plate 1 produced in Example 1 to the same surface acrylic coating treatment is referred to as comparative sample plate 9.

These samples were subjected to a 42-day accelerated exposure test with EYE Super UV Tester, manufactured by Iwasaki Electric Co., Ltd., at an ultraviolet irradiation intensity of 90 MW/cm². This 42-day exposure test corresponds to 12,000-hour irradiation with a 250-W mercury lamp having a rated life of 12,000 hours. The results obtained are shown in Table 2.

Comparative sample plate 8, which had undergone no surface treatment, came to have a ground-glass-like surface at 20 days after the initiation of the exposure and became unable to be evaluated. In contrast, sample plate 3 of the invention did not change in surface state even through the 42-day exposure. This sample plate 3 of the invention was examined for absorption spectrum and, as a result, the 410-nm transmittance thereof was found to be 0.05%, which was unchanged from the transmittance value thereof as measured before the irradiation. This sample showed almost no yellowing. Comparative sample plate 9 underwent an increase in 410-nm transmittance (a decrease in light-shielding effect) through the irradiation and the yellowing thereof was visually observed, although this sample underwent no change in surface state.

TABLE 2

| | | Transmittance T (%) |
|---|---|---|
| | State of surface | before and after |
| | after exposure | exposure |
| | test | (410 nm) |
| Sample plate 3 of | no change through | before exposure: 0.05% |
| the invention | 42-day exposure | after exposure: 0.05% |
| (surface-treated | | |
| sample) | | |
| Comparative sample | changed to ground- | unable to be evaluated |
| plate 8 | glass-like | |
| (surface-untreated | appearance in | |
| sample) | 20-day exposure | |
| Comparative sample | no change through | before exposure: 0.05% |
| plate 9 | 42-day exposure | after exposure: 0.30% |
| (surface-treated | | |
| sample) | | |

The polycarbonate resin molding of the invention can provide an illuminator cover, which does not deteriorate even in intense ultraviolet.

The entire disclosure of each and every foreign patent application from which the benefit of foreign priority has been claimed in the present application is incorporated herein by reference, as if fully set forth.

1. A polycarbonate resin molding comprising a polycarbonate resin composition,
wherein the polycarbonate resin composition comprises: a polycarbonate resin; at least one of an ultraviolet absorber and a fluorescent whitening agent; a hindered amine; and a hindered phenol,
wherein the polycarbonate resin molding has a light transmittance of 0.1% or lower in a wavelength of not longer than 410 nm.

2. The polycarbonate resin molding according to claim 1, comprising:
at least one of (A) 0.01 to 30% by weight of the ultraviolet absorber and (B) 0.01 to 30% by weight of the fluorescent whitening agent;
(C) 0.01 to 30% by weight of the hindered amine; and
(D) 0.01 to 30% by weight of the hindered phenol, each based on the polycarbonate resin.

3. The polycarbonate resin molding according to claim 1, further comprising a protective layer as an outermost layer of the polycarbonate resin molding.

4. The polycarbonate resin molding according to claim 3,
wherein the protective layer is an acrylic coat.

5. An illuminator cover comprising a polycarbonate resin molding according to claim 1.

6. The illuminator cover according to claim 5, which covers an HID (High Intensity Discharge) lamp.

7. The illuminator cover according to claim 5, which covers an illuminator for a vehicle.

8. An illuminator lens comprising a polycarbonate resin molding according to claim 1.

9. The illuminator lens according to claim 8, which covers an illuminator for a vehicle.

10. The polycarbonate resin molding according to claim 1,
wherein the fluorescent whitening agent is represented by formula (I): 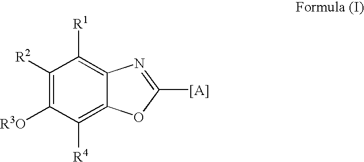
wherein R¹ and R⁴ each independently represents a hydrogen atom, an alkyl group or an alkoxy group;
R² and R³ each independently represents an alkyl group; and
[A] represents a substituted aryl group or a substituted ethenyl group.

11. The polycarbonate resin molding according to claim 10,
wherein the fluorescent whitening agent is represented by formula (II): 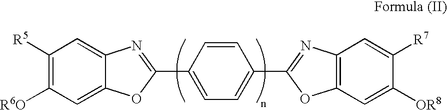
wherein R⁵ to R⁸ each independently represents an alkyl group; and
n represents an integer of 1 or 2.

12. A method for producing a polycarbonate resin molding, comprising:
extrusion molding a polycarbonate resin composition, so as to form an extruded polycarbonate resin composition; and
blow molding the extruded polycarbonate resin composition,
wherein the polycarbonate resin composition comprises: at least one of an ultraviolet absorber and a fluorescent whitening agent; a hindered amine; and a hindered phenol.

13. A method for producing a polycarbonate resin molding, comprising injection molding a polycarbonate resin composition,
wherein the polycarbonate resin composition comprises: at least one of an ultraviolet absorber and a fluorescent whitening agent; a hindered amine; and a hindered phenol.
